(19) United States
(12) Patent Application Publication
(10) Pub. No.: US 2025/0178169 A1
(43) Pub. Date: Jun. 5, 2025

(54) TOOL FOR REMOVAL AND/OR INSERTION OF A FILTER

(71) Applicant: Genentech, Inc., South San Francisco, CA (US)

(72) Inventors: Nicholas RUMMEL, San Francisco, CA (US); Patrick Daniel AHYOW, Mountain View, CA (US); Joseph Mark F. PEREZ, South San Francisco, CA (US)

(73) Assignee: Genentech, Inc., South San Francisco, CA (US)

(21) Appl. No.: 18/954,225

(22) Filed: Nov. 20, 2024

Related U.S. Application Data
(63) Continuation of application No. PCT/US2023/023055, filed on May 22, 2023.
(60) Provisional application No. 63/344,936, filed on May 23, 2022.

(51) Int. Cl. B25B 27/00

(52) U.S. Cl. CPC B25B 27/0042

(57) ABSTRACT

Embodiments described herein relate to a tool comprising a cylindrical member having a cylindrical tube portion with a circular opening at a first end of the cylindrical member, and a protrusion disposed on an inner surface of the cylindrical tube portion. In various embodiments, the tool includes a plurality of protrusions that are disposed equal-distant from one another along a circumference on the inner surface of the cylindrical tube portion. In various embodiments, the cylindrical member comprises a second cylindrical tube portion with a second circular opening on a second end of the cylindrical member. In various embodiments, the protrusion has a varying height that gradually increases from a first end of the protrusion to a second end. In various embodiments, the protrusion is disposed at a slanted angle with respect to the circular opening where the first end is closer to the circular opening than the second end.

### CROSS-REFERENCE TO RELATED APPLICATIONS

The present application is a continuation of the PCT Application No. PCT/US2023/023055, filed May 22, 2023, which claims priority to U.S. Provisional Patent Application No. 63/344,936, filed May 23, 2022, each of which is hereby incorporated by reference in its entirety.

### FIELD

The present disclosure generally relates to a tool or a device, and in particular, relates to a tool/device for manipulation, removal, installation, and/or insertion of an object.

### BACKGROUND

In laboratories, such as a biotechnology lab, bioreactor systems are used for fermentation or cell culturing. Such systems require highly controlled environments that demand the need for clean reactors and sensors between experiments or culturing runs while enabling all media, gas, liquid and sensor connections to be made, quickly and simply, for fast turnaround between experiments. To keep these disparate media and bioreactor compartments of the systems in clean and uncontaminated, filtration systems are often used to keep parts or all of the systems clean for optimum performance. In various bioreactor systems, filters are used in the filtration systems to maintain a clean system while minimizing contamination and down time between and during experiments. However, replacing filters are often cumbersome, thus causing unnecessary down time during experimental runs. Thus, a system for replacing such filters quickly and inexpensively is contemplated, and as such, there is a need for a tool, a device, or a system that is inexpensive and that is specifically configured to remove used/spent filters and insert new filters.

### SUMMARY

In accordance with various embodiments disclosed herein, a tool for manipulating a filter is provided. In various embodiments, the tool includes a cylindrical member having a cylindrical tube portion with a circular opening at a first end of the cylindrical member; and a protrusion disposed on an inner surface of the cylindrical tube portion, wherein the protrusion protrudes vertically away from the inner surface and has a varying height along a length of the protrusion, wherein the varying height gradually increases from a first end of the protrusion to a second end of the protrusion.

In various embodiments, the protrusion is disposed at a slanted angle with respect to the circular opening and wherein the first end of the protrusion is closer to the circular opening than the second end. In various embodiments, the protrusion is an elongated wedge and wherein the varying height at its farthest point from the inner surface has a sharp edge. In various embodiments, the varying height of the protrusion gradually increases away from the circular opening. In various embodiments, the protrusion is a first protrusion, the tool further includes a second protrusion disposed at an equal distance from the first protrusion along a circumference on the inner surface of the cylindrical tube portion. In various embodiments, the first protrusion and the second protrusion are oriented in a same direction and disposed at a same distance away from the circular opening.

In various embodiments, the tool further includes a plurality of protrusions, wherein the plurality of protrusions are disposed equal-distant from one another along a circumference on the inner surface of the cylindrical tube portion. In various embodiments, the cylindrical member further comprises a closed end at a second end of the cylindrical tube.

In various embodiments, the cylindrical tube portion of the cylindrical member is a first cylindrical tube portion and the circular opening of the cylindrical tube portion is a first circular opening, the cylindrical member further includes a second cylindrical tube portion with a second circular opening on a second end of the cylindrical member. In various embodiments, the inner surface of the first cylindrical tube portion is a first inner surface, wherein the second cylindrical tube portion has a second inner surface, wherein the second inner surface is a smooth surface without any protrusions.

In various embodiments, the tool further includes a handle coupled to the cylindrical member, the handle configured to provide grip for manipulating the cylindrical member, wherein the tool is configured to remove and/or insert a filter. In various embodiments, the cylindrical member has a diameter less than 12 mm and the circular opening of the cylindrical tube portion has a diameter greater than 9 mm.

In accordance with various embodiments disclosed herein, a tool for manipulating a filter is provided. In various embodiments, the tool includes a cylindrical member having a first cylindrical tube portion at a first end of the cylindrical member and a second cylindrical tube portion at a second end of the cylindrical member; and a protrusion disposed on an inner surface of the first cylindrical tube portion.

In various embodiments, the first cylindrical tube portion comprises a first circular opening having a first diameter and the second cylindrical tube portion comprises a second circular opening having a second diameter, wherein the first diameter and the second diameter are the same. In various embodiments, the first diameter and the second diameter are greater than 9 mm and the cylindrical member has a diameter less than 12 mm. In various embodiments, the protrusion forms an elongated wedge having a first end and a second end, the second end having a sharp edge, and wherein the protrusion is oriented at a slanted angle with respect to the circular opening with the first end being closer to the circular opening than the second end.

In various embodiments, the protrusion is a first protrusion, the tool further includes one or more protrusions, wherein the first protrusion and the one or more protrusions are disposed equal-distant from one another along a circumference on the inner surface of the first cylindrical tube portion.

In accordance with various embodiments disclosed herein, a tool for manipulating a filter is provided. In various embodiments, the tool includes a cylindrical member having a cylindrical tube portion with a circular opening at a first end of the cylindrical member, wherein the cylindrical member has a diameter less than 12 mm and the circular opening of the cylindrical tube portion has a diameter greater than 9 mm; and a handle coupled to the cylindrical member, the handle configured to provide grip for manipulating the cylindrical member.

In various embodiments, the circular opening is a first circular opening, the cylindrical member further includes a second cylindrical tube portion with a second circular opening at a second end of the cylindrical member; and a plurality of protrusions disposed on an inner surface of the second cylindrical tube portion. In various embodiments, the plurality of protrusions each comprise a sharp tip, are equal-distant from one another, and are disposed along a circumference on the inner surface of the second cylindrical tube portion.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIGS. 1A-1H illustrate various schematic views of a tool, in accordance with various embodiments.

FIGS. 2A and 2B illustrate schematic views of a tool, in accordance with various embodiments.

FIGS. 3A and 3B illustrate schematic views of a tool, in accordance with various embodiments.

FIGS. 4A-4D depict images of a tool for manipulating a filter, in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

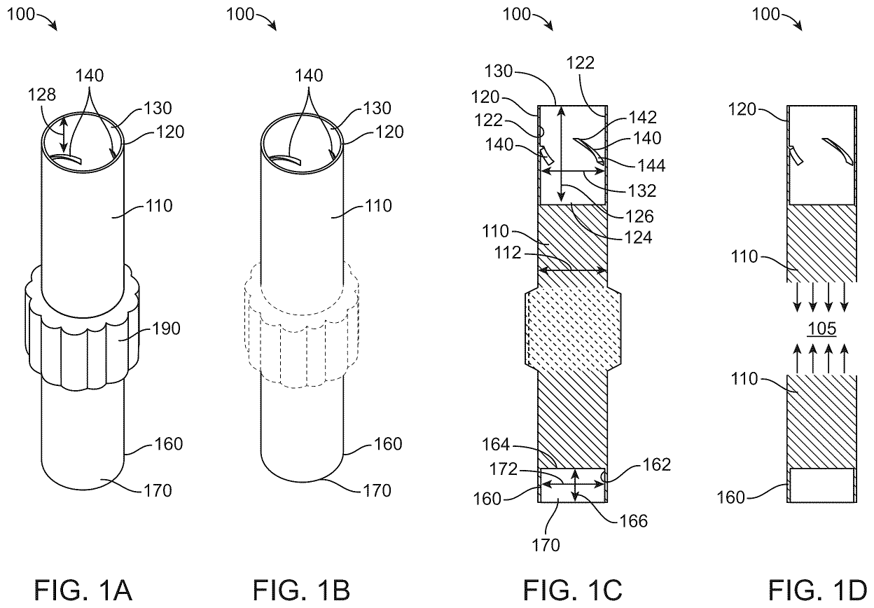

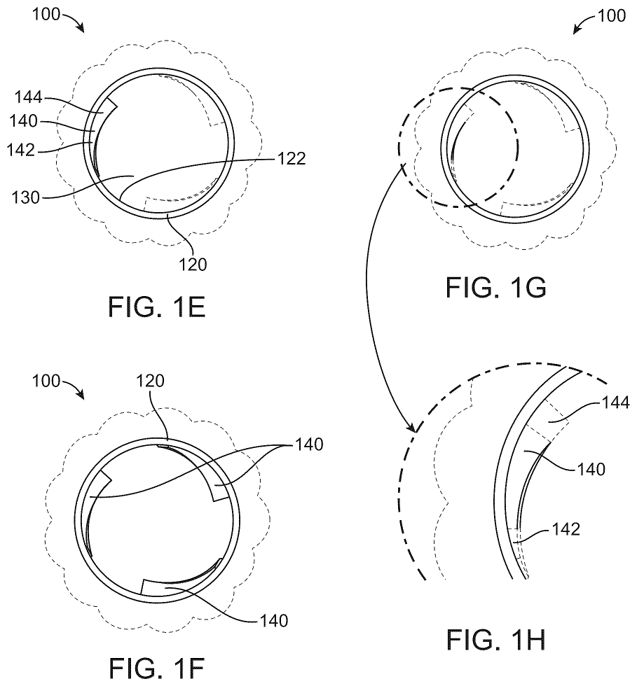

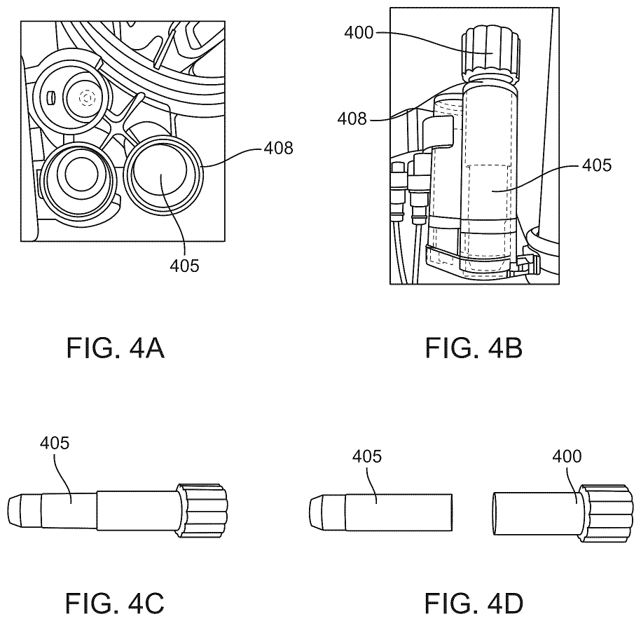

The technologies disclosed herein relate to a tool comprising a cylindrical member having a cylindrical tube portion with a circular opening at a first end of the cylindrical member, and a protrusion disposed on an inner surface of the cylindrical tube portion. In various embodiments, the tool includes a plurality of protrusions that are disposed equal-distant from one another along a circumference on the inner surface of the cylindrical tube portion. In various embodiments, the cylindrical member comprises a second cylindrical tube portion with a second circular opening on a second end of the cylindrical member. In various embodiments, the protrusion has a varying height that gradually increases from a first end of the protrusion to a second end. In various embodiments, the protrusion is disposed at a slanted angle with respect to the circular opening where the first end is closer to the circular opening than the second end. To further describe the various embodiments disclosed herein, example schematics of a tool are illustrated with respect to FIGS. 1A-1H, 2A, 2B, 3A, and 3B. In accordance with various embodiments, the tool illustrated in FIGS. 1A-1H, 2A, 2B, 3A, and 3B is configured to remove and/or insert, or otherwise manipulate, a filter, as shown in FIGS. 4A-4D.

FIGS. 1A-1H illustrate various schematic views of a tool 100, in accordance with various embodiments. In particular, FIGS. 1A and 1B illustrate perspective views of the tool 100, FIG. 1C illustrates a cross-sectional view of the tool 100, FIG. 1D illustrates an embodiment of the tool 100 that includes two portions that can be integrated to form the tool 100, and FIGS. 1E, 1F, 1G, and 1H illustrate bird's eye views of the tool 100, in accordance with various embodiments.

As illustrated in FIGS. 1A, 1B, and 1C, the tool 100 includes a cylindrical member 110 having a cylindrical tube portion 120 (e.g., a first cylindrical tube portion) with a circular opening 130 (e.g., a first circular opening) at a first end of the cylindrical member 110. In various embodiments, the cylindrical tube portion 120 includes a protrusion 140 disposed on an inner surface 122 (e.g., a first inner surface) of the cylindrical tube portion 120. As illustrated in FIG. 1C, the protrusion 140 protrudes vertically away from the inner surface 122 and has a varying height along a length of the protrusion 140, in accordance with various embodiments. In some embodiments, the varying height of the protrusion 140 gradually increases from a first end 142 of the protrusion 140 to a second end 144 of the protrusion 140, as illustrated in bird's eye view of the tool 100 in FIGS. 1E-1H. In various embodiments, the protrusion 140 can be disposed at a slanted angle with respect to the circular opening 130, as illustrated in FIGS. 1A, 1B, and 1C. As illustrated in the FIGS., the first end 142 of the protrusion 140 is closer to the circular opening 130 than the second end 144 of the protrusion 140, in accordance with various embodiments. In some embodiments, the protrusion 140 is an elongated wedge, and in some embodiments, the varying height of the protrusion 140 at its farthest point away from the inner surface 122 is a sharp edge or a sharp tip. In various embodiments, the varying height of the protrusion 140 gradually changes, e.g., increases, away from the circular opening 130, as illustrated in FIG. 1C. In accordance with the illustration of FIG. 1C, the first end 142 of the protrusion 140 is closer to the circular opening 130 than the second end 144 of the protrusion 140. In other words, the protrusion 140 forms a knife-like wedge/edge that is configured to tear and/or hook into the filter (e.g., filter 405 of FIGS. 4A-4D) as the protrusion 140 is inserted into a filtration tube 408 of FIGS. 4A-4D. In doing so, upon pulling out from the filtration tube 408, for example, the filter 405 can be removed from the filtration tube 408 via a hook-like action provided by the protrusion 140 of the tool 100, in accordance with various embodiments.

As illustrated in FIGS. 1A, 1B, and 1C, the tool 100 also includes a cylindrical tube portion 160 (e.g., a second cylindrical tube portion) with a circular opening 170 (e.g., a second circular opening) on a second end of the cylindrical member 110. In various embodiments, the cylindrical tube portion 160 has an inner surface 162 (e.g., a second inner surface). In various embodiments, the inner surface 162 does not have any protrusion disposed thereon. In various embodiments, the inner surface 162 is a smooth surface.

In some embodiments, rather than the cylindrical tube portion 160 with the circular opening 170 on the second end of the cylindrical member 110, the cylindrical member 110 includes a closed end at the second end of the cylindrical member 110.

In some embodiments, the tool 100 may be an integrated tool that includes two portions (e.g., two cylindrical members 110), where the first cylindrical member 110 has the cylindrical tube portion 120 and the second cylindrical member 110 has the cylindrical tube portion 160, as illustrated in FIG. 1D. In some embodiments, the two portions, i.e., the two cylindrical members 110, can be combined, integrated, or coupled, as indicated by arrows 105 in FIG. 1D, to form an integrated tool version of the tool 100.

In various embodiments, the tool 100 includes a handle 190 coupled to the cylindrical member 110, as illustrated in FIG. 1A. In some embodiments, a handle 190 may not be part of the tool 100, as illustrated with dashed portions in FIGS. 1B and 1C. In various embodiments, the handle 190 is configured to provide grip for manipulating (e.g., insertion of a filter or removal of a filter, such as filter 405 of FIGS. 4A-4D) the cylindrical member 110. In various embodiments, the handle 190 may be ribbed, patterned, or otherwise textured to provide ample gripping capability.

As illustrated in FIGS. 1A-1H, the cylindrical member 110 has a diameter 112 less than 12 mm, in accordance with various embodiments. In some embodiments, the diameter 112 is less than 50 mm, less than 25 mm, less than 20 mm, less than 15 mm, or less than 10 mm.

In various embodiments, the circular opening 130 of the cylindrical tube portion 120 has a diameter 132 greater than 9 mm, in accordance with various embodiments. In some embodiments, the diameter 132 is greater than 1 mm, greater than 2 mm, greater than 3 mm, greater than 5 mm, greater than 7 mm, greater than 8 mm, greater than 9 mm, greater than 9.5 mm, greater than 10 mm, greater than 10.5 mm, greater than 11 mm, or greater than 11.5 mm.

In various embodiments, the circular opening 170 of the cylindrical tube portion 160 has a diameter 172 greater than 9 mm, in accordance with various embodiments. In some embodiments, the diameter 172 is greater than 1 mm, greater than 2 mm, greater than 3 mm, greater than 5 mm, greater than 7 mm, greater than 8 mm, greater than 9 mm, greater than 9.5 mm, greater than 10 mm, greater than 10.5 mm, greater than 11 mm, or greater than 11.5 mm.

In various embodiments, the circular opening 130 and the circular opening 170 has the same diameter. In various embodiments, the circular opening 130 and the circular opening 170 has slightly different diameters. In various embodiments, the circular opening 130 and the circular opening 170 have a diameter difference of about 2%, 4%, 6%, 8%, or 10%.

In various embodiments, the cylindrical tube portion 120 has a base surface 124 at a distance 126 away from the circular opening 130, as illustrated in FIG. 1C. In various embodiments, the distance 126 is determined such that at least a portion of the filter (e.g., filter 405 of FIGS. 4A-4D) can be fit into the cylindrical tube portion 120 for removal from a filtration tube 408 of FIGS. 4A-4D.

In various embodiments, the cylindrical tube portion 160 has a base surface 164 at a distance 166 away from the circular opening 170, as illustrated in FIG. 1C. In various embodiments, the distance 166 is determined such that at least a portion of the filter (e.g., filter 405 of FIGS. 4A-4D) can be inserted into the cylindrical tube portion 120 for insertion into a filtration tube 408 of FIGS. 4A-4D.

Now referring to FIG. 1E, the bird's eye views of the tool 100 illustrate the protrusion 140 disposed on the inner surface 122, in accordance with various embodiments. FIG. 1F illustrates the tool 100 with three of the protrusions 140 disposed on the inner surface 122. In various embodiments, the tool 100 can include a second protrusion, a third protrusion, or any suitable number of protrusions (e.g., a plurality of protrusions 140) that can be disposed on the inner surface 122. In various embodiments, the plurality of protrusions 140 can be disposed equal-distant from one another along a circumference on the inner surface 122 of the cylindrical tube portion 120. If there are two protrusions 140, the first protrusion 140 and the second protrusion 140 can be disposed at an equal distance from one another along a circumference on the inner surface 122.

In various embodiments, the protrusions 140, whether two, three, or any number of protrusions, can be oriented in a same direction and disposed at a distance 128 away from the circular opening 130. In various embodiments, the distance 128 can be less than or about 1 mm from the circular opening 130. In various embodiments, the distance 128 can be less than or about 2 mm, less than or about 3 mm, less than or about 4 mm, less than or about 5 mm, less than or about 6 mm, less than or about 7 mm, less than or about 8 mm, less than or about 8 mm, less than or about 10 mm, less than or about 15 mm, or less than or about 20 mm.

In various embodiments, the tool 100 can comprise polylactide (PLA), which is a thermoplastic material derived from lactic monomers. In various embodiments, the tool 100 can comprise any plastic material, metal, alloy, etc. In various embodiments, the tool 100 can be manufactured via a suitable process, including but not limited to, additive manufacturing, substrative manufacturing, 3D printing, injection molding, extrusion, etc.

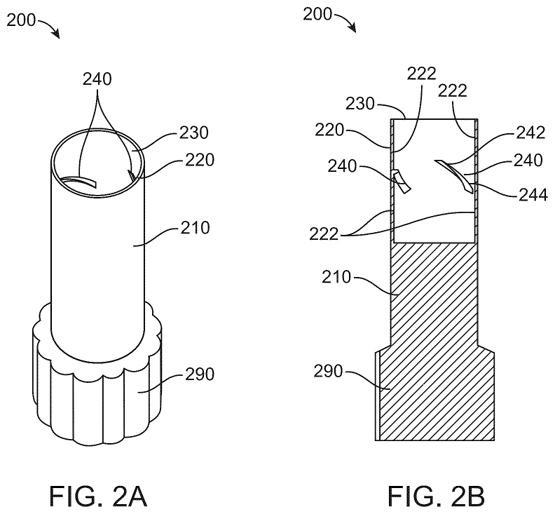

FIGS. 2A and 2B illustrate schematic views of a tool 200, in accordance with various embodiments. As illustrated in FIGS. 2A and 2B, the tool 200 includes a cylindrical member 210 having a cylindrical tube portion 220 with a circular opening 230 at a first end of the cylindrical member 210. In various embodiments, the cylindrical tube portion 220 includes a protrusion 240 disposed on an inner surface 222 of the cylindrical tube portion 220. As illustrated in FIG. 2B, the protrusion 240 protrudes vertically away from the inner surface 222 and has a varying height along a length of the protrusion 240, in accordance with various embodiments. In some embodiments, the varying height of the protrusion 240 gradually increases from a first end 242 of the protrusion 240 to a second end 244 of the protrusion 240.

In various embodiments, the protrusion 240 can be disposed at a slanted angle with respect to the circular opening 230, as illustrated in FIGS. 2A and 2B. As illustrated in the figures, the first end 242 of the protrusion 240 is closer to the circular opening 230 than the second end 244 of the protrusion 240. In some embodiments, the protrusion 240 is an elongated wedge, and in some embodiments, the varying height of the protrusion 240 at its farthest point away from the inner surface 222 is a sharp edge or a sharp tip. In various embodiments, the varying height of the protrusion 240 gradually changes, e.g., increases, away from the circular opening 230, as illustrated in FIG. 2B. In accordance with the illustration of FIG. 2B, the first end 242 of the protrusion 240 is closer to the circular opening 230 than the second end 244 of the protrusion 240. In other words, the protrusion 240 is identical or substantially the same as the protrusion 140 as described with respect to FIGS. 1A-1H.

In various embodiments, the tool 200 also includes a handle 290 coupled to the cylindrical member 210, as illustrated in FIGS. 2A and 2B. In various embodiments, the handle 290 is configured to provide grip for removal of a filter, such as filter 405 of FIGS. 4A-4D. In various embodiments, the handle 290 may be ribbed, patterned, or otherwise textured to provide ample gripping capability. In various embodiments, the tool 300 may not include the handle 390.

In accordance with various embodiments, the dimensions and properties of the cylindrical member 210, the cylindrical tube portion 220, the circular opening 230 of the cylindrical tube portion 220, the protrusion 140 (including the number and arrangement of protrusions 140 with respect to the various components of the tool 200) are the same or substantially the same as those of the tool 100 as described with respect to FIGS. 1A-1H, and thus, will not be described in further detail.

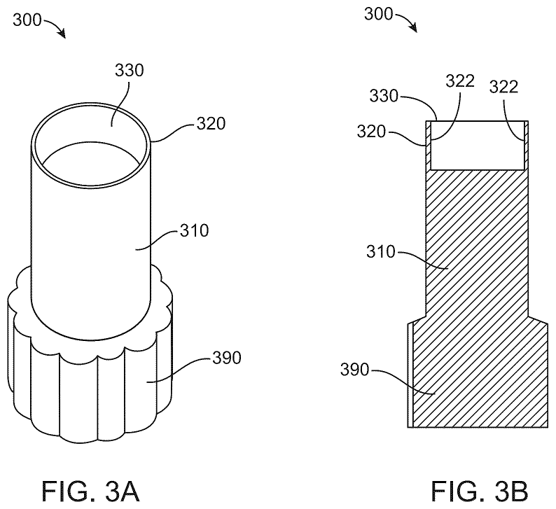

FIGS. 3A and 3B illustrate schematic views of a tool, in accordance with various embodiments. As illustrated in FIGS. 3A and 3B, the tool 300 includes a cylindrical member 310 having a cylindrical tube portion 320 with a circular opening 330 at a first end of the cylindrical member 310. In various embodiments, the cylindrical tube portion 310 has an inner surface 322; however, it does not have any protrusion disposed thereon. In various embodiments, the inner surface 322 is a smooth surface. In other words, the cylindrical tube portion 310 is identical or substantially the same as the cylindrical tube portion 160 as described with respect to FIGS. 1A-1H, and thus, will not be described in further detail.

As illustrated in FIGS. 3A and 3B, the tool 300 also includes a handle 390 coupled to the cylindrical member 310. In various embodiments, the handle 390 is configured to provide grip for insertion of a filter, such as filter 405 of FIGS. 4A-4D. In various embodiments, the handle 390 may be ribbed, patterned, or otherwise textured to provide ample gripping capability. In various embodiments, the tool 300 may not include the handle 390.

In accordance with various embodiments, the dimensions and properties of the cylindrical member 310, the cylindrical tube portion 320, the circular opening 330 of the cylindrical tube portion 320 are the same or substantially the same as the cylindrical member 110, the cylindrical tube portion 160, the circular opening 170 of the cylindrical tube portion 160, respectively, of the tool 100 as described with respect to FIGS. 1A-1H, and thus, will not be described in further detail.

FIGS. 4A-4D depict images of a tool 400 for manipulating a filter 405, in accordance with various embodiments. In accordance with various embodiments, the tool 400 is the same or substantially identical to the tool 100 and 200 as illustrated and described with respect to FIGS. 1A-1H and 2A-2B, respectively. As illustrated in FIGS. 4A-4D, the tool 400 can be used to insert or remove the filter 405 to and from the filtration tube 408. FIG. 4A illustrates filter 405 being stored inside the filtration tube 408. FIG. 4B illustrates the tool 400 being inserted into the filtration tube 408, in which the cylindrical tube portion (e.g., cylindrical tube portions 110 or 210) of the tool 400 is placed over an outer diameter of the filter 405 and within the opening of the filtration tube 408. Upon applying a twisting motion while inserting the tool 400 into the filtration tube 408, the protrusion(s) (e.g., protrusion(s) 140 or 240) can lodge it (themselves) into the filter 405, and upon retraction of the tool 400 from the filtration tube 408, the filter 405 is removed. FIG. 4C illustrates the tool 400 with the filter 405 still hooked into the protrusions on the inner surface of the cylindrical tube portion of the filter 400. FIG. 4D illustrates the filter 405 removed from the tool 400. The slanted etched lines on the removed filter 405 shows the “tooth marks” of the protrusions.

In accordance with various embodiments described herein, a system for replacing a filter quickly and inexpensively is achieved via the tools 100, 200, 300, and 400 as described with respect to FIGS. 1A-1H, 2A-2B, 3A-3B, and 4A-4D.

While the present teachings are described in conjunction with various embodiments, it is not intended that the present teachings be limited to such embodiments. On the contrary, the present teachings encompass various alternatives, modifications, and equivalents, as will be appreciated by those of skill in the art. The present description provides preferred exemplary embodiments, and is not intended to limit the scope, applicability, or configuration of the disclosure. Rather, the present description of the preferred exemplary embodiments will provide those skilled in the art with an enabling description for implementing various embodiments.

It is understood that various changes may be made in the function and arrangement of elements without departing from the spirit and scope as set forth in the appended claims. Thus, such modifications and variations are considered to be within the scope set forth in the appended claims. Further, the terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed.

In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

Specific details are given in the present description to provide an understanding of the embodiments. However, it is understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A tool, comprising:
a cylindrical member having a cylindrical tube portion with a circular opening at a first end of the cylindrical member; and
a protrusion disposed on an inner surface of the cylindrical tube portion,
wherein the protrusion protrudes vertically away from the inner surface and has a varying height along a length of the protrusion, wherein the varying height gradually increases from a first end of the protrusion to a second end of the protrusion.

2. The tool of claim 1, wherein the protrusion is disposed at a slanted angle with respect to the circular opening and wherein the first end of the protrusion is closer to the circular opening than the second end.

3. The tool of claim 1, wherein the protrusion is an elongated wedge and wherein the varying height at its farthest point from the inner surface has a sharp edge.

4. The tool of claim 1, wherein the varying height of the protrusion gradually increases away from the circular opening.

5. The tool of claim 1, wherein the protrusion is a first protrusion, further comprising:
a second protrusion disposed at an equal distance from the first protrusion along a circumference on the inner surface of the cylindrical tube portion.

6. The tool of claim 1, wherein the first protrusion and the second protrusion are oriented in a same direction and disposed at a same distance away from the circular opening.

7. The tool of claim 1, further comprising a plurality of protrusions, wherein the plurality of protrusions are disposed equal-distant from one another along a circumference on the inner surface of the cylindrical tube portion.

8. The tool of claim 1, wherein the cylindrical member further comprises a closed end at a second end of the cylindrical tube.

9. The tool of claim 1, wherein the cylindrical tube portion of the cylindrical member is a first cylindrical tube portion and the circular opening of the cylindrical tube portion is a first circular opening, the cylindrical member further comprises:
a second cylindrical tube portion with a second circular opening on a second end of the cylindrical member.

10. The tool of claim 9, wherein the inner surface of the first cylindrical tube portion is a first inner surface, wherein the second cylindrical tube portion has a second inner surface, wherein the second inner surface is a smooth surface without any protrusions.

11. The tool of claim 1, further comprising:
a handle coupled to the cylindrical member, the handle configured to provide grip for manipulating the cylindrical member, wherein the tool is configured to remove and/or insert a filter.

12. The tool of claim 1, wherein the cylindrical member has a diameter less than 12 mm and the circular opening of the cylindrical tube portion has a diameter greater than 9 mm.

13. A tool, comprising:
a cylindrical member having a first cylindrical tube portion at a first end of the cylindrical member and a second cylindrical tube portion at a second end of the cylindrical member; and
a protrusion disposed on an inner surface of the first cylindrical tube portion.

14. The tool of claim 13, wherein the first cylindrical tube portion comprises a first circular opening having a first diameter and the second cylindrical tube portion comprises a second circular opening having a second diameter, wherein the first diameter and the second diameter are the same.

15. The tool of claim 14, wherein the first diameter and the second diameter are greater than 9 mm and the cylindrical member has a diameter less than 12 mm.

16. The tool of claim 13, wherein the protrusion forms an elongated wedge having a first end and a second end, the second end having a sharp edge, and wherein the protrusion is oriented at a slanted angle with respect to the circular opening with the first end being closer to the circular opening than the second end.

17. The tool of claim 13, wherein the protrusion is a first protrusion, further comprising one or more protrusions, wherein the first protrusion and the one or more protrusions are disposed equal-distant from one another along a circumference on the inner surface of the first cylindrical tube portion.

18. A tool, comprising:
a cylindrical member having a cylindrical tube portion with a circular opening at a first end of the cylindrical member, wherein the cylindrical member has a diameter less than 12 mm and the circular opening of the cylindrical tube portion has a diameter greater than 9 mm; and
a handle coupled to the cylindrical member, the handle configured to provide grip for manipulating the cylindrical member.

19. The tool of claim 18, wherein the circular opening is a first circular opening, the cylindrical member further comprises:
a second cylindrical tube portion with a second circular opening at a second end of the cylindrical member; and
a plurality of protrusions disposed on an inner surface of the second cylindrical tube portion.

20. The tool of claim 19, wherein the plurality of protrusions each comprise a sharp tip, are equal-distant from one another, and are disposed along a circumference on the inner surface of the second cylindrical tube portion.
